(19) United States
(12) Patent Application Publication
(10) Pub. No.: US 2025/0159395 A1
(43) Pub. Date: May 15, 2025

(54) HEADPHONES

(71) Applicant: Sennheiser electronic SE & Co. KG, Wedemark (DE)

(72) Inventors: Olaf Leske, Langenhagen (DE); Olav Nisse, Hildesheim (DE); David Schunack, Burgwedel (DE); Gunnar Dirks, Hannover (DE)

(73) Assignee: Sennheiser electronic SE & Co. KG, Wedemark (DE)

(21) Appl. No.: 18/947,315

(22) Filed: Nov. 14, 2024

(30) Foreign Application Priority Data
Nov. 15, 2023 (DE) 102023131869.1

(51) Int. Cl. H04R 1/10

(52) U.S. Cl. CPC H04R 1/1008; H04R 1/105

(57) ABSTRACT

A headphone (100) is provided which comprises a headband (200) with a first and second headband end (210, 220) and a first and second fork (300) at the first and second headband ends (210, 220). The first and second fork (300) each have a first and second fork arm (310, 320). The first and second fork arms (310, 320) of the first fork (300) span a first fork plane and the first and second fork arms (310, 320) of the second fork (300) span a second fork plane. The headphone (100) has a first and second bracket rotation axis (330) which is provided in the region of a first end (340) of the fork (300) in a transition region to a headband (200) or a slider (500) in the region of the first and second headband. The fork (300) is coupled to a slider (500) or to a first or second end (210, 220) of the headband by means of a bracket rotation axis (330), wherein first and second auricles (400) are each pivotally coupled to second ends (350) of the first and second bracket. The first and second auricles (400) each have a first and second auricle side (410, 420). The first and second bracket rotation axis (330) each have an angle α to the first and second bracket plane in the direction of the first auricle side (410), wherein a is between 2 and 6°.

In areas where headphones are worn for long periods of time, such as in the studio, the comfort of a headphone is very important.

In the priority application of this application, the German Patent and Trademark Office has searched the following documents: DE 10 2014 213 534 A1, US 2005/0 053 255 A1, US 2014/0 205 129 A1, U.S. Pat. No. 5,862,241 A, US 949 825 S, US 978 825 S, WO 2017/027 410 A1 and CN 208 905 170 U.

It is therefore an object of the present invention to provide a headphone which has improved comfort.

This object is achieved by a headphone according to claim 1.

Thus, a headphone comprising a headband with a first and second headband end is shown. The headband can span a headband plane. A fork is provided at each of the two headband ends to accommodate an auricle. The first and second forks each have a first and second fork arm and a first and second fork end. The first and second fork arms of the first fork span a first fork plane and the first and second fork arms of the second fork span a second fork plane. The forks are configured to be rotatable via a first and second fork rotation axis. A first auricle is coupled to the first and second fork arm of the first fork via the first pivot axis. The second auricle is pivotably coupled via the first and second fork arms of the second fork via a second auricle pivot axis. The first fork rotation axis has an angle α with respect to the first fork plane in the direction of the first auricle side and the second fork rotation axis has an angle α with respect to the second fork plane in the direction of the first auricle side. The angle α is between 2 and 6°, preferably 4°.

By pivoting the fork rotation axis towards an inside (between the first and second fork), the forces with which the first auricle side presses against a head of a user (when the headphone is the same in front and behind the ear of a user) is more uniform, in particular in front and behind the ear of a user.

The fork rotation axis is pivoted such that the fork rotation axis crosses a plane spanned by the first auricle side substantially centric in front of the ear when the headphone is used.

The invention also relates to headphones comprising a headband with a metal bracket that acts as a spring and a first and second headband end. The headband spans a headband plane and the first and second headband ends are each configured to be curved at a radius R. A first and second fork are each coupled to the first and second headband ends, which each have a first and second fork arm and a first and second fork end. The first and second forks serve to accommodate the first and second auricles. A first and second slider are displaceable along the first and second headband ends. The first fork is rotatably coupled to the first slider and the second fork is rotatably coupled to the second slider via the first and second fork rotation axes. The first slider accommodates the first headband end and the second slider accommodates the second headband end. By moving the first and second sliders along the first and second curved headband ends, a distance A between the second ends of the first and second fork arms is reduced when the first and second sliders are moved toward the first and second headband ends.

According to one aspect, the earpiece comprises a first and second slider having a first and second end, wherein the first ends are configured to receive a first or second headband end in such a manner that the slider is slidable along the headband.

According to one aspect, the headphones have a headband with a metal bracket that acts as a spring and a first and second headband end, wherein the first and second headband ends are each bent at a radius R. The headphones have a first and second fork each for receiving an auricle at the first and second headband ends, which each serve a first and second fork arm each for receiving a first and second auricle. The headphones have a first and second slider, which have a first and second end, wherein the first end is configured in such a manner that it can receive the first or second headband end in such a manner that the slider is at least partially movable along the headband. The first fork is rotatably coupled to the first slider and the second fork is rotatably coupled to the second slider via a first and second fork rotation axis. By moving the first and second slider along the first and second curved headband portion, a distance A between the second ends of the first and second fork arms is reduced when the first and second slider are moved towards a first and second headband end.

According to one aspect, the headphone comprises two ear pads arranged on the first auricle sides, wherein the ear pads have an ear pad cover and an ear pad volume material.

According to one aspect, the ear pad volume material can be configured as visco-elastic foam to ensure that the ear pad can be washed.

Further embodiments of the invention are the subject of the dependent claims.

Advantages and exemplary embodiments of the invention are explained in more detail below with reference to the drawing.

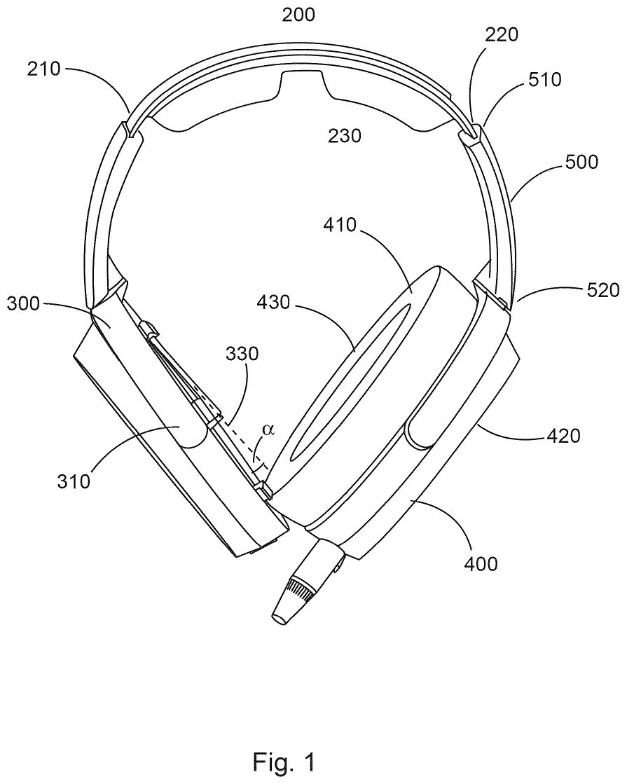

FIG. 1 shows a schematic representation of a headphone,

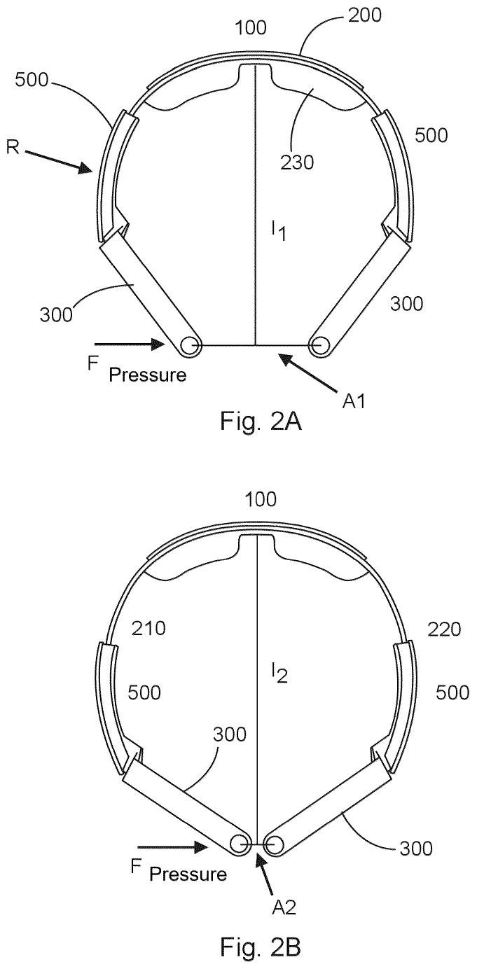

FIG. 2A show a representation of a headband with two forks and 2B each for receiving an auricle,

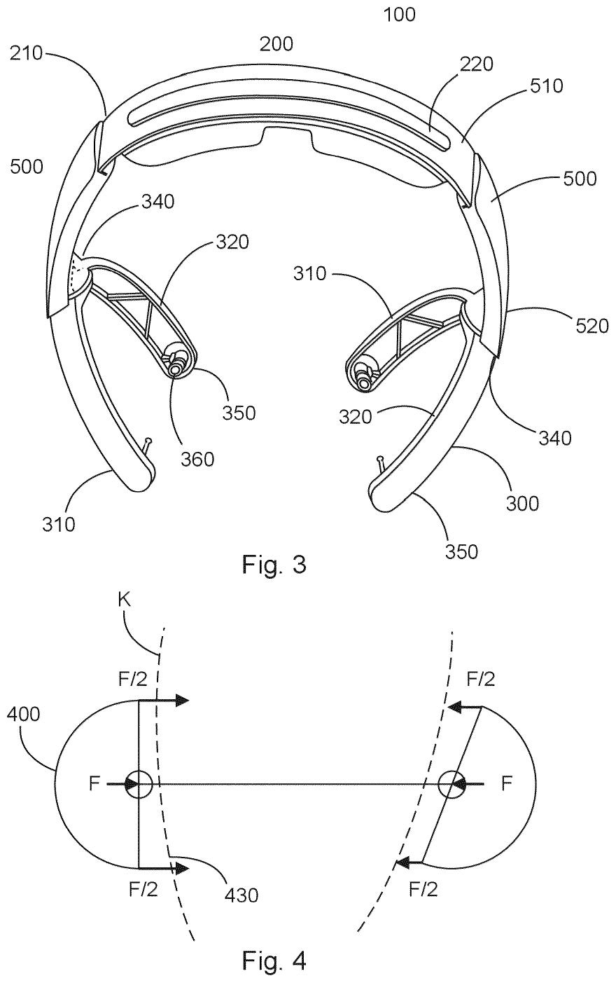

FIG. 3 shows a perspective view of a headband with two forks each for receiving an auricle,

FIG. 4 shows a schematic representation of a force distribution in a headphone,

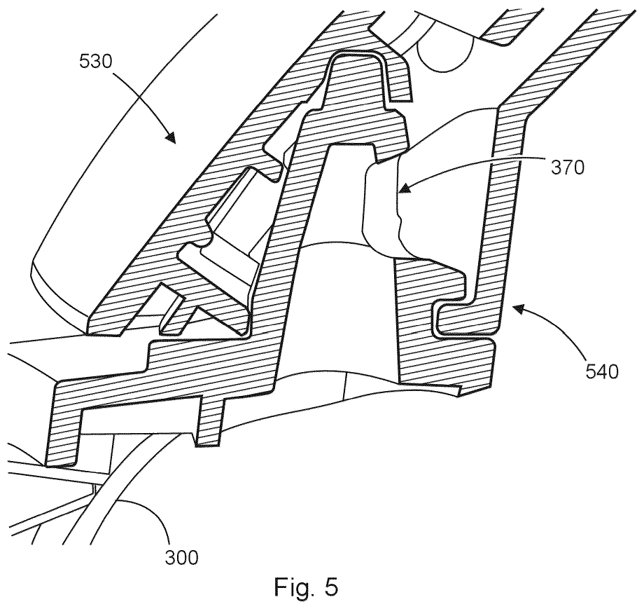

FIG. 5 shows a perspective sectional view of a transition between a fork and a slider of a headphone,

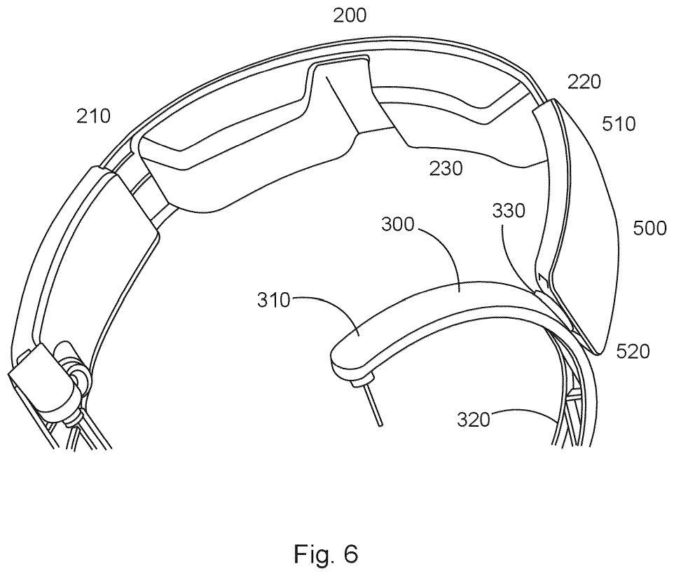

FIG. 6 shows a perspective view of a headband with two forks each for receiving an auricle,

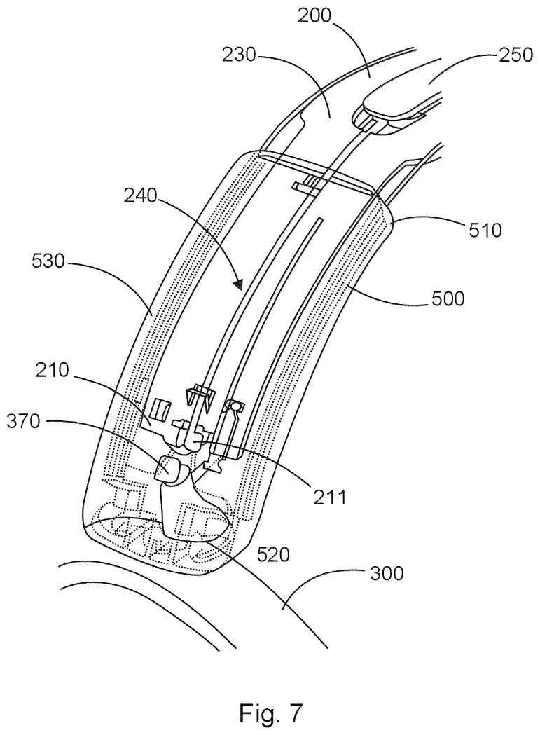

FIG. 7 shows a schematic view of a slider in a headphone,

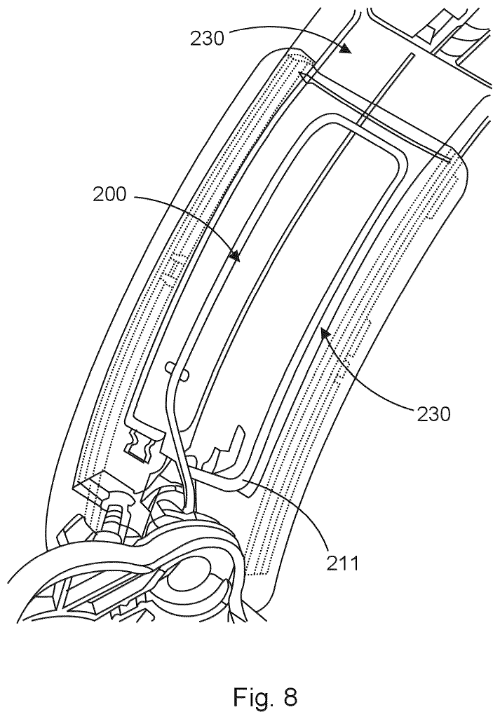

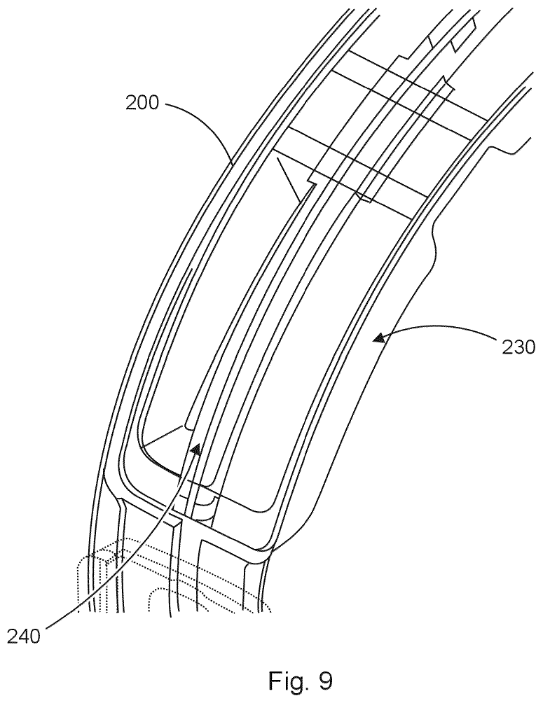

FIG. 8 shows a further schematic representation of a transition between a slider and a fork for receiving an auricle,

FIG. 9 shows another schematic representation of a cable guide at a transition between a slider and a headband,

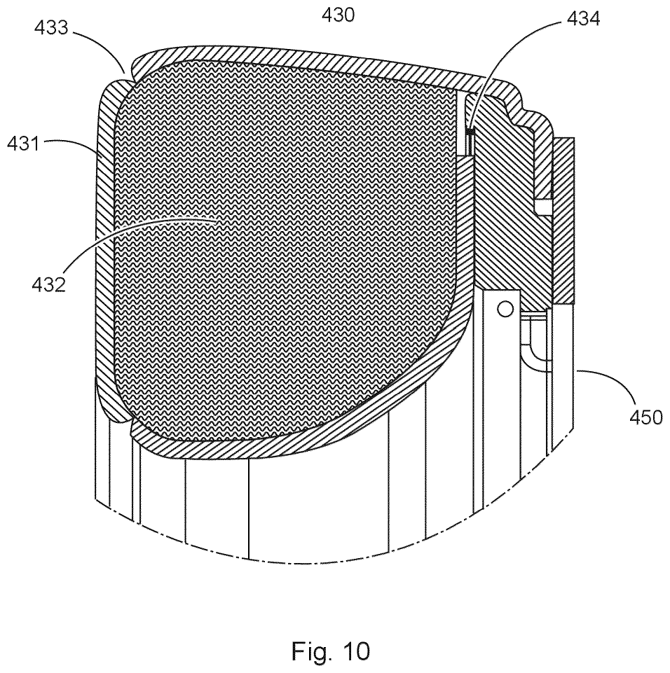

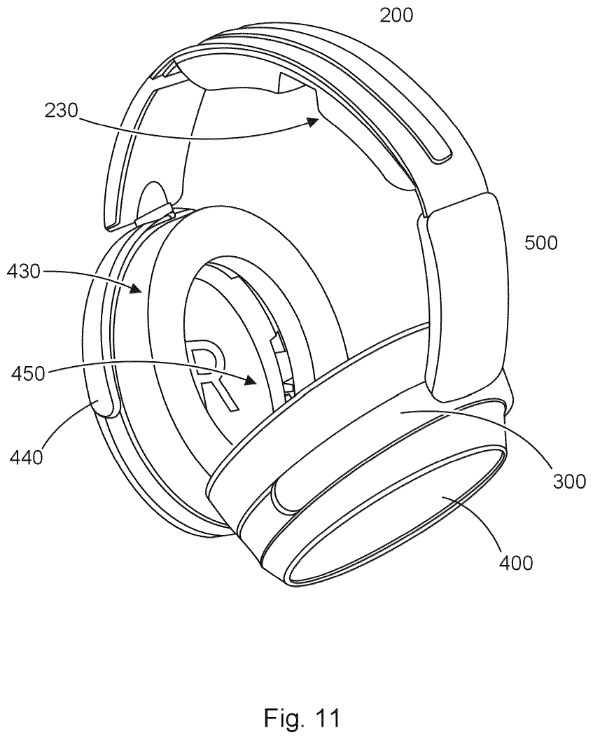

FIG. 10 shows a schematic sectional view of an ear pad,

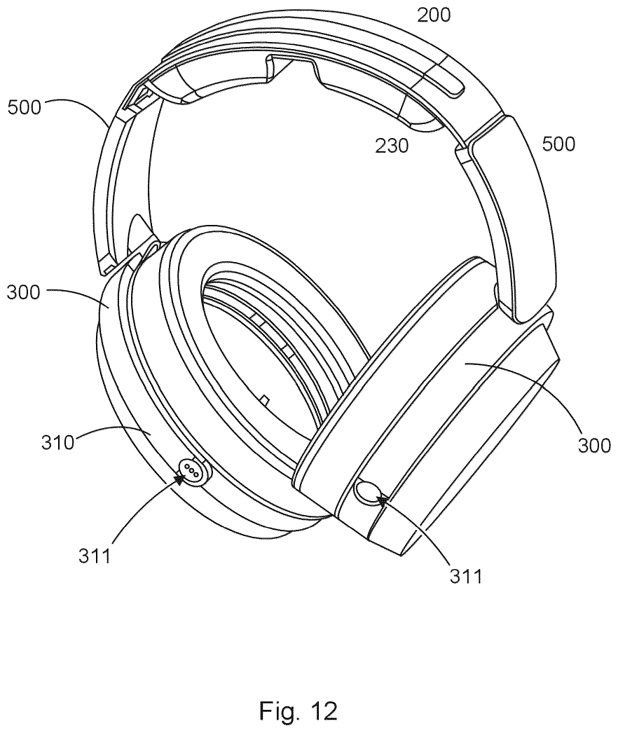

FIG. 11 shows a perspective view of a headphone, and

FIG. 12 shows a perspective view of a headphone.

FIG. 1 shows a schematic representation of a headphone. The headphone 100 has a headband 200 with a first and second headband end 210, 220 and two sliders 500 which can be moved along the headband ends 210, 220. A first and second fork 300 is each rotatably coupled to the sliders 500. The forks 300 each serve to accommodate an auricle 400.

Head pads 230 can be provided on the headband 200. The width of the head pads 230 can be selected such that the first ends 510 of the sliders 500 do not touch the head pads 230 when retracted. This ensures that the sliders or the actuation of the sliders does not lead to damage to the head pads 230. The fork 300 has a first and second fork arm 310, 320 and a first end where the fork 300 is coupled to a slider 500 or to an end of the headband via a fork rotation axis 330. The fork rotation axis 330 is arranged at an angle relative to a fork plane which is spanned by the first and second fork arms. In particular, the fork rotation axis 330 is pivoted slightly towards an inside of the headphone (towards the first auricle side or the inside of the auricle, i.e. towards the inside end).

The pivoted angle of the bracket rotation axis 330 is a and between 2 and 6°, preferably 4°.

An auricle 400 has a first and a second side 410, 420. The first side 410 represents the side facing the ear and the second side 420 represents the side facing away from the ear. Furthermore, the first and second auricles 400 are each pivotally coupled to the first and second ends of the fork arms 310, 320. An ear pad 430 is provided on the first auricle side 410.

The auricle 400 is thus configured to be rotatable by means of the fork rotation axis 330 and pivotable by means of the pivot axis. The angle α between the fork rotation axis 330 and the plane spanned by the first and second fork arms is between 2 and 6°, in particular 4°.

The first and second slider 500 has a first and second slider end 510, 520. The first slider end 510 receives the first or second headband end 210, 220. The second headband end 520 of the slider 500 is coupled to the fork 300 via a fork rotation axis 330. Optionally, an additional pivot axis can also be provided here.

FIGS. 2A and 2B each show a representation of a headband with two forks, each for receiving an auricle. FIGS. 2A and 2B each show a headband 200 with two sliders 500 and two forks 300. In FIG. 2A, the sliders 500 are in the retracted state, i.e. the first and second ends of the headband 210, 220 are received in one of the two sliders 500. In this case, the distance between the headband and the ends of the fork arms is I1 and a distance A1 between the ends of the fork arms is present. In FIG. 2B, the two sliders 500 are shown in the extended state. Here, the distance A2 between the fork ends is smaller than in the retracted state of FIG. 2A. Furthermore, the distance between the headband and the second ends L1 is greater than in FIG. 2A.

The same fork pressure is achieved for the user in both extended positions. FIG. 2B shows an extended state in which the distance between the auricles is reduced compared to FIG. 2A. In order to put the earphone on in this state, the auricles must be pulled further apart (than in FIG. 2A). This compensates for the longer lever to the metal spring, so that the pressure for the user is always substantially the same regardless of the size setting of the headband.

FIG. 3 shows a perspective view of a headband with two forks, each for receiving an auricle. The headphones have a headband 200 with a first and second end 210, 220 and two sliders 500 in the area of the first and second headband ends 210, 220. The sliders 500 receive the first or second headband end 210, 220 and are displaceable along the headband 200. In other words, the first end 510 of the slider 500 receives a first or second headband end 210, 220. The slider is rotatably coupled to the second end 520 with the first or second fork 300. The first and second forks 300 each have a first and second fork arm 310, 320, a first fork end 340 and a second fork end 350. The first fork end 340 is coupled to the second end 520 of the slider 500. The second fork end 350 is located at the ends of the first and second fork arms 310, 320. In the area of the second ends 350, a pivot axis element 360 is provided on each of the first and second fork arms 310, 320. By means of this element, the ends of the first and second fork arms 310, 320 can be coupled in or on an auricle 400, so that the auricle 400 is configured to be pivotable by means of this pivot axis.

FIG. 4 shows a schematic representation of a force distribution in a headphone. FIG. 4 shows the force distribution in a headphone according to the invention. In particular, due to the configuration of the fork rotation axis (at an angle α with respect to the bracket plane spanned by the first and second fork arms 310, 320) it can be achieved that the ear pads 430 exert a uniform pressure force F on a head K of a user. It should be emphasized here that because of the angle α the forces acting on the user are substantially always the same for both ends of the ear pads.

As the bracket rotation axis 330 is pivoted by the angle α out of the plane (spanned by first and second bracket arms) towards the inside, i.e. towards the head of a user when the headphone is worn, the pressure force F pressing against the head of a user is more uniform, namely F/2 behind the ear and F/2 in front of the ear of a user.

FIG. 5 shows a perspective sectional view of a transition between a fork and a slider of a headphone. In FIG. 5, in particular, a fork guide dome 370 of the fork, a slider cover 530 and a slider lid 540 are shown.

The fork guide dome 370 can be provided, in particular clamped, between the slider cover 530 and the slider lid 540. This allows the fork 300 and thus the auricle 400 to be moved when the slider 500 is moved.

FIG. 6 shows a perspective view of a headband with two forks, each for receiving an auricle. FIG. 6 shows in particular a headphone headband 200, a slider 500 and a fork 300. The headband 200 has a first and second headband end 210, 220 and a head pad 230 on the inside. The two sliders 500 are arranged in the area of the first and second headband end 210, 220 in such a manner that a first end 510 of the slider can receive the first or second headband end 210, 220 in such a manner that the slider 500 can be moved along the first or second headband end. At a second end 520 of the slider, a fork 300 with a first and second arm 310, 320 and a fork rotation axis 330 is provided at the second end 520.

FIG. 7 shows a schematic view of a slider in a headphone. The slider is shown schemat-ically in FIG. 7. The headband 200 has a metal bracket 250 which serves as a spring. An overhead cable 240 can run from a first slider 500 or from one auricle 400 through the headband 210 to the other auricle 400. In particular, the overhead cable 240 can run in the area of the metal bracket 250 (underneath or over). In FIG. 7, the slider is shown in the inserted state, i.e., the first end 210 points far into the slider 500. The length of the overhead cable 240, particularly in the area of the first and second headband ends 210, 220, must be selected so that the slider can be moved unhindered along the bracket. The cable 240 is connected to the metal bracket 250 via a cable holder 211.

FIG. 8 shows a further schematic representation of a transition between a slider and a fork. In FIG. 8, in particular, a first end 241 of the overhead cable 240 is shown. The first end 241 has a length which is sufficiently large so that the slider 500 can be displaced along the first or second headband end 210, 220.

In particular, an inner or lower side of the headband is shown in FIG. 8. The first end 241 extends in a loop to allow a displacement or extension of the slider.

FIG. 9 shows a further schematic representation of a cable guide at a transition between a slider and a headband. In FIG. 9, an area of the headband is shown in particular, for example in the area of the pad. Here, the overhead cable runs underneath the metal bracket, so that the overhead cable 240 can be provided between the metal bracket and the pad.

FIG. 10 shows a schematic sectional view of an ear pad. The ear pad 430 has an ear pad cover 431 and an ear pad volume material 432 such as a foam. The ear pad cover 431 can be sewn using a seam 433. Alternatively or additionally, the ear pad cover 431 can be glued using an adhesive 434. Furthermore, a dust protection 450 can be provided.

In the case of headphones which are worn for a long period of time, the ear pad may become damaged.

In the headphones according to the invention, the two ear pads and the head pad can be removed without tools. The ear pads and the head pad can be washed in a washing ma-chine, for example at 40° C. This is advantageous because the hygiene of the ear pad can thereby be improved.

In order to achieve the washability of the ear pads, the selection of the surface material, that is, the selection of the ear pad cover, the selection of the foam as the ear pad volume material, and the way the ear pad cover is assembled together with the volume material must be considered.

The ear pad cover 431 can, for example, be a velour material with a higher acoustic impedance. Alternatively, a fabric material with a lower acoustic impedance can be provided as the ear pad cover. The ear pad cover 431 can, for example, consist of 100% polyester and can be designed to be elastic in both surface directions. This is advantageous because shrinkage due to washing can be prevented. The ear pad cover 431 can have a coating on its inside, which helps to stabilize the structure. An adhesive bonding of the inner coating can be configured to be water-resistant.

It can thereby be achieved that the materials retain their tactile properties even after washing.

The ear pad volume material 432 can be configured as visco-elastic foam. The foam in the ear pad is compressed by long-term and repeated wear. This can be regenerated by washing so that the ear pad regains its original volume.

FIG. 11 shows a perspective view of a headphone. In FIG. 11, three removable pads, namely the two ear pads 430 and the head pad 230 and the removable dust cover 450, are shown.

The auricle 460 can be pivoted via a pivot axis 440.

FIG. 12 shows a perspective view of a headphone. FIG. 12 shows a headphone 100 comprising a headband 200 with a first and second headband end 210, 220. A slider 500 is provided on each of the first and second headband ends 210, 220, which has a first and second end. The first and second headband ends are received by the slider at the first end 210. A first and second fork are coupled to a second end of the slider 500. A first and second auricle is each coupled to a second end of the fork. A marking 311 for distinguishing between left and right can be provided on a first or second fork arm.

### REFERENCE LIST

100 Headphones
200 Headband
210 First headband end
211 Cable holder
220 Second headband end
230 Head pad
240 Overhead cable
241 First overhead cable end
250 Metal bracket
300 Fork
310 First fork arm
311 Marking
320 Second fork arm
330 Fork rotation axis
340 First temple end
350 Second temple end
360 Pivot axis element
370 Fork guide dome
400 Auricle
410 First side of the auricle
420 Second side of the auricle
430 Ear pads
431 Ear pad cover
432 Ear pad volume material
433 Seam
434 Adhesive bonding
440 Pivot axis
450 Dust protection
460 Auricle
500 Slider
510 First slider end
520 Second slider end
530 Slider cover
540 Slider lid
K Head
R Radius

1. Headphones (100), comprising
a headband (200) with a first and second headband end (210, 220),
a first and second fork (300) at the first and second headband ends (210, 220), each having a first and second end, wherein the first and second forks (300) each have a first and second fork arm (310, 320), the first and second fork arms (310, 320) of the first fork (300) span a first fork plane and the first and second fork arms (310, 320) of the second fork (300) span a second fork plane,
a first and second fork rotation axis (330) which are provided in the region of a first end of the fork (300) in a transition region to a headband (200) or a slider (500) in the region of the first and second headband ends (210, 220),
wherein the first and second forks (300) are each coupled to a slider (500) or to a first or second end (210, 220) of the headband by means of a fork rotation axis (330), wherein first and second auricles (400) are each pivotally coupled to second ends (350) of the first and second headband (200),
wherein the first and second auricles (400) each have a first and second auricle side (410, 420), wherein the first auricle side (410) faces inwardly,
wherein the first and second fork rotation axes (330) each have an angle α with respect to the first and second fork plane towards the first auricle side (410), wherein a is between 2 and 6°.

2. Headphones (100) according to claim 1, further comprising
a first and a second slider (500) having a first and a second end (510, 520), wherein the first ends (510) are configured to receive a first or second headband end (210, 220) in such a manner that the slider (500) is slidable along the headband (200).

3. Headphones (100), in particular according to claim 1, further comprising
a headband (200) with a metal bracket (250) acting as a spring and a first and second headband end (210, 220), wherein the first and second headband ends (210, 220) are each bent at a radius R,
a first and second fork (300) each for receiving an auricle (400) at the first and second headband ends (210, 220), each of which has a first and second fork arm (310, 320) each for receiving a first and second auricle (400),
a first and a second slider (500) having a first and a second end (510, 520), wherein the first end (510) is configured in such a manner that it can receive the first or second headband end (210, 220) in such a manner that the slider (500) is at least partially movable along the headband (200),
wherein the first fork (300) is rotatably coupled to the first slider (500) and the second fork (300) is rotatably coupled to the second slider (500) via a first and second fork rotation axis (330),
wherein by sliding the first and second sliders (500) along the first and second curved headband portion, a distance A between the second ends of the first and second bracket arms (310, 320) is reduced when the first and second sliders (500) are moved towards a first and second headband end (210, 220).

4. Headphones (100) according to claim 1, further comprising
two ear pads (430) arranged on the first auricle sides (410), wherein the ear pads (430) have an ear pad cover (431) and an ear pad volume material (432).

5. Headphones (100) according to claim 1, wherein
the ear pad volume material (432) can be configured as visco-elastic foam to ensure washability of the ear pad (430).

6. Headphones (100), in particular according to claim 2, further comprising
a headband (200) with a metal bracket (250) acting as a spring and a first and second headband end (210, 220), wherein the first and second headband ends (210, 220) are each bent at a radius R,
a first and second fork (300) each for receiving an auricle (400) at the first and second headband ends (210, 220), each of which has a first and second fork arm (310, 320) each for receiving a first and second auricle (400),
a first and a second slider (500) having a first and a second end (510, 520), wherein the first end (510) is configured in such a manner that it can receive the first or second headband end (210, 220) in such a manner that the slider (500) is at least partially movable along the headband (200),
wherein the first fork (300) is rotatably coupled to the first slider (500) and the second fork (300) is rotatably coupled to the second slider (500) via a first and second fork rotation axis (330),
wherein by sliding the first and second sliders (500) along the first and second curved headband portion, a distance A between the second ends of the first and second bracket arms (310, 320) is reduced when the first and second sliders (500) are moved towards a first and second headband end (210, 220).

7. Headphones (100) according to claim 2, further comprising
two ear pads (430) arranged on the first auricle sides (410), wherein the ear pads (430) have an ear pad cover (431) and an ear pad volume material (432).

8. Headphones (100) according to claim 3, further comprising
two ear pads (430) arranged on the first auricle sides (410), wherein the ear pads (430) have an ear pad cover (431) and an ear pad volume material (432).
